(19) United States
(12) Patent Application Publication
(10) Pub. No.: US 2024/0238746 A1
(43) Pub. Date: Jul. 18, 2024

(54) THERMAL INVERTER BOX

(71) Applicant: TI-Holdings B.V., Amsterdam (NL)

(72) Inventors: Rudolf KOEKKOEK, Amsterdam (NL); Terence VECHIK, Amsterdam (NL)

(73) Assignee: TI-Holdings B.V., Amsterdam, BM (NL)

(21) Appl. No.: 18/686,232

(22) PCT Filed: Aug. 25, 2022
(86) PCT No.: PCT/IB2022/057960

§ 371 Date: Feb. 23, 2024

(30) Foreign Application Priority Data
Aug. 25, 2021 (AU) 2021107333
Aug. 25, 2021 (AU) 2021229172

(51) Int. Cl. B01J 6/00; B01D 53/24; C01B 3/04; C01B 13/02; F02M 21/02; F02M 31/02

(52) U.S. Cl. CPC B01J 6/008; B01D 53/24; C01B 3/045; C01B 13/0207; F02M 21/0206; F02M 31/02

(57) ABSTRACT

The invention relates to a thermal converter (1, 2) for generating from a parent compound a first fluid of first molecules (H2) with a first molecular weight and a second fluid of second molecules (O2) with a second molecular weight, whereby the first molecular weight of the first molecules (H2) is less than the second molecular weight of the second molecules (O2).

In order to improve the efficiency of the thermal converter, the thermal converter comprises a spray device (18) for generating from the parent compound in fluid form a spray, which is supplied to a reaction device (1) for splitting the parent compound into a mixture compound of the first molecules (H2) and the second molecules (O2).

### TECHNICAL FIELD OF THE INVENTION

The invention relates to a thermal converter for generating from a parent compound a first fluid of first molecules with a first molecular weight and a second fluid of second molecules with a second molecular weight, whereby the first molecular weight of the first molecules is less than the second molecular weight of the second molecules, the thermal converter comprising a reaction device for splitting a fluid into a compound of the first molecules and the second molecules and a gas separator device.

The invention further relates to an arrangement of thermal converter and a combustion engine.

The invention also relates to a procedure for generating hydrogen and oxygen gas.

### PRIOR ART

From WO 2005/005009 A2 a radiant energy transfer reactor is known, into which water molecules, preferably in the form of steam or water vapor is introduced. The radiant energy is absorbed by the molecules which dissociate into hydrogen and oxygen. In a separation step a time variant magnetic field is used to cause a rotation of the dissociated hydrogen and oxygen and enhancing the separation of hydrogen and oxygen due to a centrifugal effect by the magnetic field. The hydrogen gas may be pumped into storage tanks for use elsewhere or used for powering fuel cells or combusted for other equipment proximate to the reactor.

CN200610009659A discloses a helical pipe composite gas-liquid separator in vertical structure consists of a gas collecting part, a helical centrifugal separating part and a liquid collecting part. A fluid entering to the helical pipe in the helical separating part generates a centrifugal acceleration. Under the common action of the centrifugal force and the gravitational force, the liquid with great density aggregates to the lower part of the pipeline while gas aggregates in the upper part before being exhausted through the upper holes in the helical pipe. Under the condition of lower gas content in the fluid or relatively small fluid flow rate, the fluid is separated mainly on the gas collecting part and the liquid is collected mainly in the liquid collecting part.

### SUMMARY OF THE INVENTION

The efficiency of the gas separator is crucial for the efficiency of the thermal converter. It is therefore an object of the invention to improve the efficiency of the gas separator.

The invention proposes a thermal converter for generating a first fluid of first molecules with a first molecular weight and a second fluid of second molecules with a second molecular weight, whereby the first molecular weight of the first molecules is less than the second molecular weight of the second molecules. The thermal converter comprises a reaction device for splitting a fluid into a compound of the first molecules and the second molecules. The thermal converter further comprises a spray device for generating from the parent compound in fluid form a spray, which is supplied to a reaction device for splitting the parent compound into a mixture compound of the first molecules and the second molecules.

Although any spray device may be used, spray devices which make use of the so-called Venturi effect have proven to be efficient.

In one embodiment of the invention either the first or the second outlet of the gas separator is connected to a spray medium inlet of the spray device. If the first outlet of the gas separator produces combustible molecules, then the other, the second outlet of the gas generator is connected to the spray medium inlet. In case the second outlet of the gas separator produces the combustible molecules, then the first outlet of the gas generator is connected to the spray medium inlet.

In another aspect of the invention the spray device is connected with a parent compound inlet to a fluid reservoir, wherein the fluid reservoir contains the parent compound, and with a spray outlet to a gas generator inlet of the reactor device.

An application of the invention is a combustion engine for the combustion of either the first stream of first molecules or the second stream of second molecules, as a function whether the combustible molecules are the first molecules or the second molecules. In a preferred embodiment intake valves of the combustion engine are provided with the combustible gas molecules of the gas separator. The combustible gas molecules are provided either directly, for example by supplying them into an inlet manifold of the combustion engine or indirectly by applying them to a carburetor of the combustion engine. In case water is the chosen liquid to be split into hydrogen and oxygen, the combustible molecules are the hydrogen molecules, i.e. the molecules with the lower molecular weight compared to the oxygen molecules.

Another application of the invention is in a thermal waste treatment process for the combustion of substances contained in waste materials for cleaning the flue gases.

In another aspect of the invention the heat produced by the combustion is transferred to at least of one of the gas generators or the gas superheater. In this case the waste energy produced by the combustion engine or the waste treatment process may be re-used. It may be reused to pre-heat the fluid in the fluid reservoir or to provide heat to the gas generator, the gas superheater or the reaction device.

In another aspect of the invention the parent compound is water and the first molecules are hydrogen molecules and the second molecules are oxygen molecules, in which case the combustible molecules are the hydrogen.

In another aspect of the invention a method for generating hydrogen and oxygen gas comprises the steps of converting water into a spray of water droplets; exposing water droplet to a first heat source for generating steam; exposing the steam to a second heat source for superheating the steam into supercritical steam; splitting the supercritical steam into (a mixture compound of) hydrogen molecules (H2) and oxygen molecules (O2); separating the hydrogen molecules (H2) and the oxygen molecules (O2). In an embodiment, the separating may be achieved by guiding the mixture compound into a spiral trajectory with widening diameter for forcing the oxygen molecules (O2) radially outwards and collecting the hydrogen molecules (H2) at the end of the trajectory, preferably near the axis of the spiral trajectory. It may well be that the first and the second heat source are identical.

These and other objects, advantages and features of the invention will become readily apparent from the following description of a preferred embodiment when read in conjunction with the attached drawing and appended claims.

### DETAILED DESCRIPTION

Reference will now be made to the example embodiments illustrated in the drawings, and specific language will be used herein to describe the same. It will nevertheless be understood that no limitation of the scope of the disclosure is thereby intended. Alterations and further modifications of the features illustrated herein, and additional applications of the principles illustrated herein, which would occur to one skilled in the relevant art and having possession of this disclosure, are to be considered within the scope of the disclosure.

FIG. 1 shows an overview of an arrangement for splitting water into hydrogen molecules and oxygen molecules and a gas separator for separating these molecules;

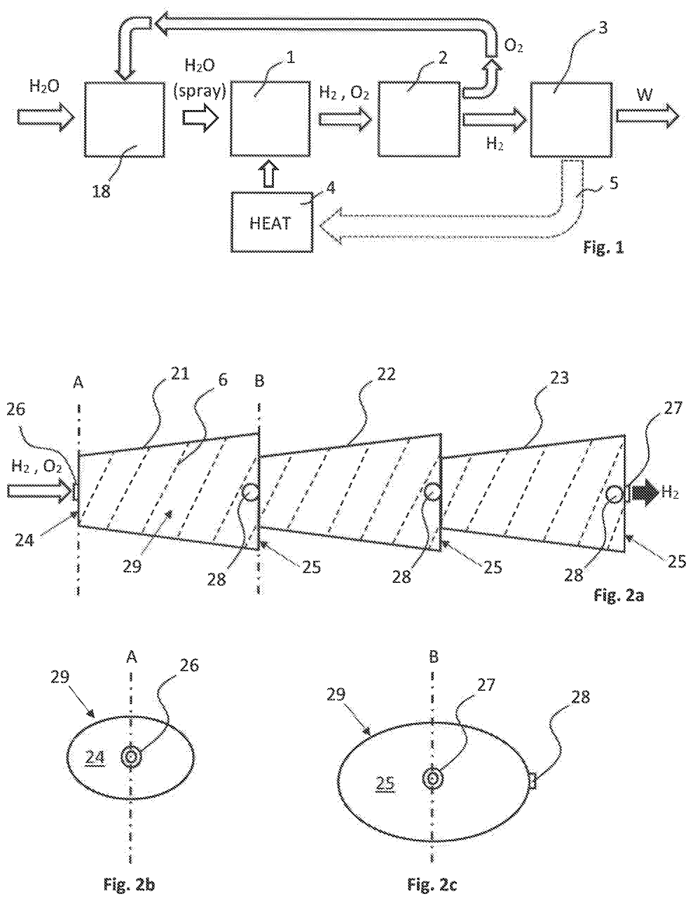

FIG. 2 shows an arrangement with three gas separator devices;

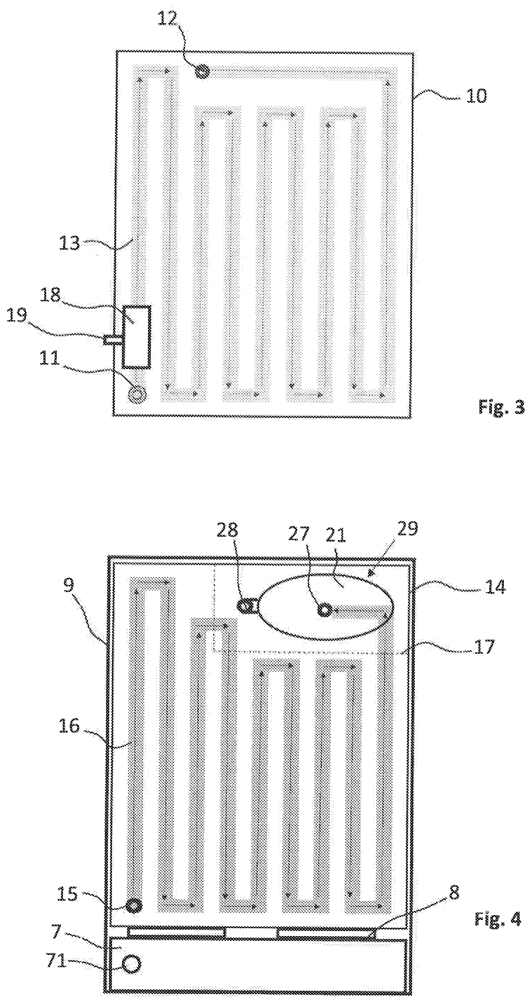

FIG. 3 shows a cross section of a gas exchanger;

FIG. 4 shows a cross section of a gas superheater/reactor device

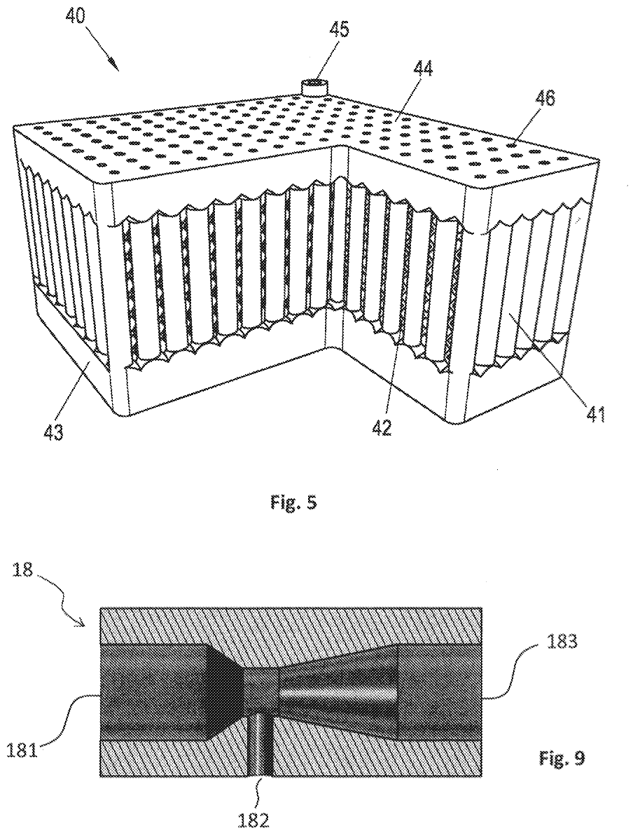

FIG. 5 shows a three-dimensional view of a reactor module

FIG. 6 shows a three-dimensional view of a thermal converter

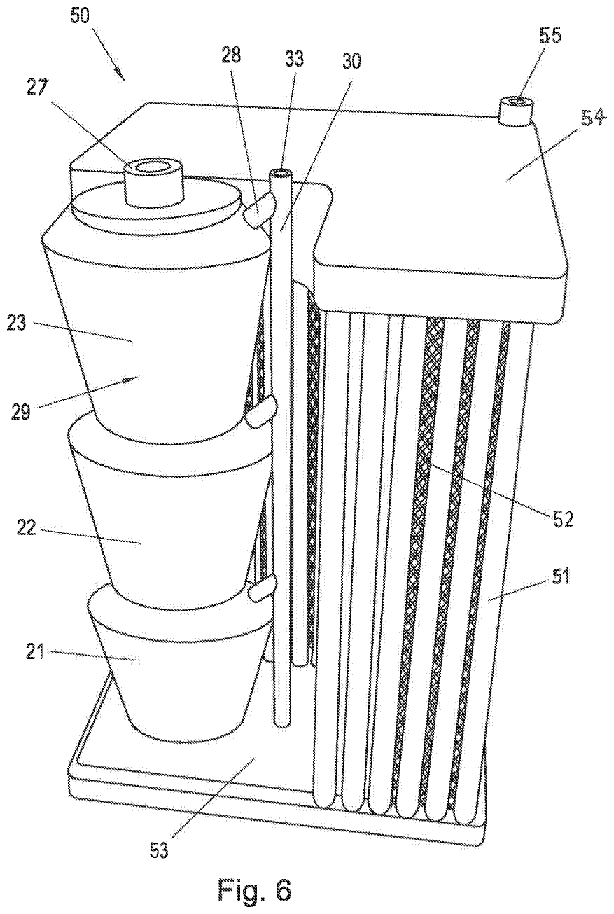

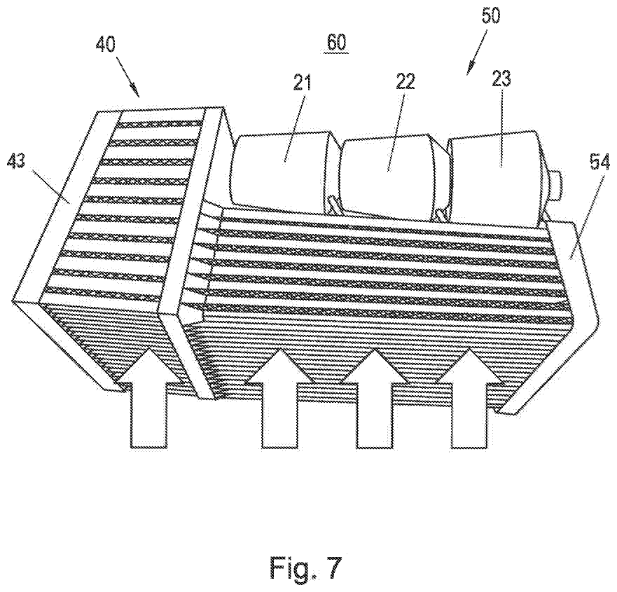

FIG. 7 shows a three-dimensional view of a thermal converter from a different angle

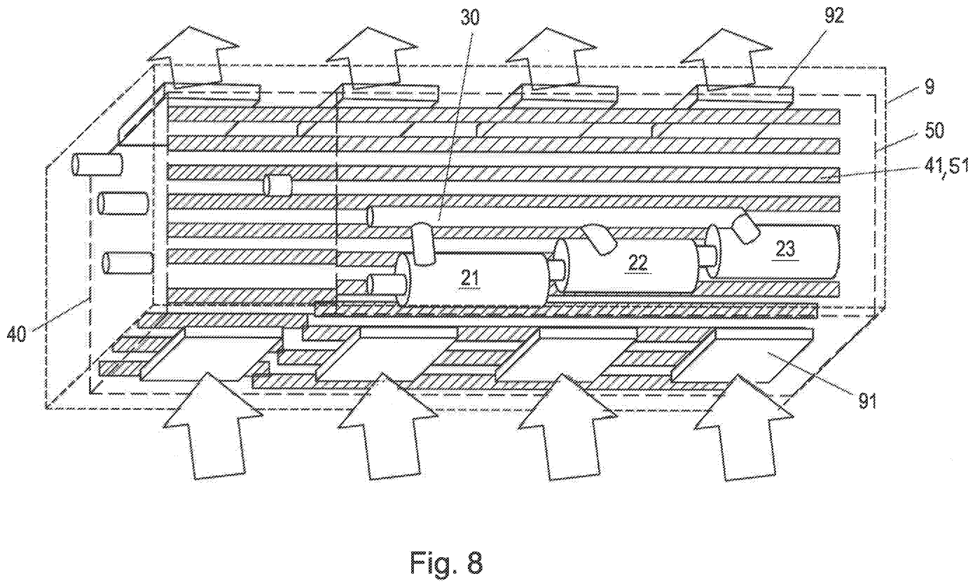

FIG. 8 shows the thermal converter as a wire-frame

FIG. 9 shows the cross section of a spray device

The invention is intended to improve the efficiency of splitting water in a gas separator module 2 into hydrogen molecules and oxygen molecules. It is well known that water, respective water steam can be split in a chemical reaction into hydrogen molecules and oxygen molecules:

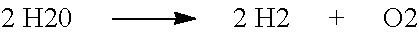

As this an endothermic reaction heat has to be added in order to make this chemical reaction happen. In case of electrolysis this may be in form of electric current. If the temperature is sufficiently high this reaction may happen by adding heat alone, which is called in general a thermolysis. In recent years various technologies have been developed by use of catalysts to reduce the temperature of the thermolysis of water.

FIG. 1 shows an overview of an embodiment of the invention. In the present embodiment a thermolysis device 1 is provided with heat from a heat source 4. The heat source 4 may be under-utilized heat of a chemical plant, an incinerator for waste disposal, or other sources. The heat is used to warm up water until it boils and changes its phase from a liquid to steam, and to further heat the steam until it reaches the temperature where the process of the decomposition of steam into its molecular components' hydrogen H2 and oxygen O2 starts.

The mixture of hydrogen molecules H2 and oxygen molecules O2 is then let to the gas separator module 2. The gas separator module 2 separates the oxygen molecules O2 from the hydrogen molecules H2. The hydrogen molecules H2 may be collected and compressed to store them as a compressed gas in a reservoir, such as a gas bottle. This would allow for transporting the gas bottles with the compressed hydrogen to a location where the hydrogen is needed, for example as a fuel. In this embodiment, the hydrogen molecules H2 are supplied as fuel, or as an additive to another fuel to an internal combustion engine 3. The internal combustion engine 3 is for example a conventional four-stroke engine which produces work W. As any other gas or gasoline engine, this engine produces under-utilized heat 5, which usually is not used and which may be transferred to the heat source 4 or alternatively be used as a second heat source for prewarming the water used in the thermolysis device 1.

In order to improve the efficiency of splitting the water into hydrogen molecules and oxygen molecules the water H20, before being applied to the thermolysis device 1 is nebulized in a spray device 18 into water spray. In order not to pollute the water spray, as a medium to tear apart the water into water droplets the oxygen gas molecules O2, which art separated from the hydrogen molecules H2 in the gas separator 2 are supplied to the spray device 18.

We turn now to FIG. 2a which shows the gas separator device 2 in a side view. In this embodiment the gas separator device 2 is composed of a first gas separator module 21, a second gas separator module 22, and a third gas separator module 23. In this embodiment the first, the second and the third gas separator module 21, 22, 23 are of identical build. Each gas separator module 21, 22, 23 has the shape of a truncated cone, or to be more precise a conical frustum with a bottom side 24 and a top side 25, which are parallel to each other. In contrast to the usual terminology, when the areas of the bottom side 24 and the top side 25 are compared, the bottom side 24 is the side with the smaller area. This terminology is used because in this application of gas separator modules 21, 22, 23 the inlet for the mixture of hydrogen and oxygen molecules H2, O2, the mixture inlet 26, is on the plane with the smaller area, at the left-hand side in the drawings, i.e. the bottom side 24. The top side 25 of the conical frustum accommodates for the hydrogen outlet 27 which is on the right-hand side of each gas separator module 21, 22, 23 in the drawings, which can be only seen for the third gas separator module 23, as the hydrogen outlet of the first and second gas separator modules are concealed in FIG. 2a. FIG. 2b depicts a view of the bottom side 24, while FIG. 2c depicts a view of the top side 25 of a gas separator module 21, 22, 23.

The first gas separator module 21, the second gas separator module 22, and the third gas separator module 23 are arranged in series, i.e. the mixture inlet 26 of the second gas separator module 22 is connected to the hydrogen outlet 27 of the first gas separator module 21 and the mixture inlet 26 of the third gas separator module 23 is connected to the hydrogen outlet 27 of the second gas separator 22. Due to this arrangement the mixture of the decomposed hydrogen molecules H2 and the oxygen molecules O2 flows in FIG. 2a from the left-hand side to the right-hand side of the drawings. Each oxygen outlet 28 of the first gas separator module 21, the second gas separator module 22, and the third gas separator module 23 are connected by an oxygen collection tube 30. For reasons of clarity the oxygen collection tube is not shown in FIG. 2a, but is shown in FIG. 6. The distance between a bottom area 24 and a top area 25 of each conical frustum is about 90 mm, so that the length of the gas separator device 2, comprising three gas separator modules 21, 22, 23 is about 270 mm in total. These dimensions are an example for an application where the thermal converter/gas separator unit supplies an internal combustion engine. It is evident that these dimensions vary with the power of the selected engine and may be smaller for smaller engines and larger for more powerful engines.

Each conical frustum of the gas separator modules 21, 22, 23 comprises inside the conical frustum guiding elements 6. The guiding elements 6 may consist of a single guiding element, or may be composed of a plurality of guiding elements 6. Effectively the guiding elements 6 form a spiral which extends from the gas mixture inlet 24 to the hydrogen outlet 27 of each gas separator module 21, 22, 23. The spiral is not rotating but is fixed to the inner walls of the conical frustum. As the inner wall is confining the spiral, a gas mixture, which is entered at the gas mixture inlet 26 is forced by the gas pressure along the path of the spiral towards the hydrogen outlet 27 and the oxygen outlet 28 and cannot bypass the spiral along the inside of sidewall 29.

A mixture of gas molecules H2, O2 which enters at the mixture inlet 26 of a gas separator module 21 is accelerated by the pressure. The gas mixture is forced in direction of the lower pressure, which is towards the hydrogen outlet 27 and the oxygen outlet 28. As there is no straight way towards the outlets 27, 28, the gas molecules of the gas mixture are forced to follow the spiral 6. This forces the gas molecules in a rotation around an imaginary axis of the spiral 6 and exerts a centrifugal force on each gas molecule. As a centrifugal force is proportional to the mass of an accelerated object, the oxygen molecules O2 with an atomic mass of thirty-two are accelerated sixteen times more than the hydrogen molecules H2 with an atomic weight of two. The oxygen molecules therefore are accelerated by the centrifugal force radially away from the imaginary axis of the spiral, i.e. in direction of the sidewall 29 of the gas separator, whereas the hydrogen molecules H2, in relation to the oxygen molecules O2 stay closer to the imaginary axis of the spiral. Therefore, the spiral separates the gas mixture H2, O2 such that gas molecules close to the sidewall 29 of the gas separator 21 are substantially oxygen molecules O2, and gas molecules close to the imaginary axis of the spiral are substantially hydrogen molecules H2. Thus, the gas molecules exiting trough the hydrogen outlet 27, which is in the centre of the top side 25 are substantially hydrogen molecules H2, and gas molecules exiting the oxygen outlet 28, which is at the sidewall 29 with the largest diameter.

In real world applications the separation of the gas molecules may not be as perfect as in theory, the gas molecules exiting the hydrogen outlet 27 still may contain a certain percentage of oxygen molecules O2. To further extract the remaining oxygen molecules in order to purify the gas mixture, the present embodiment proposes a second gas separator 22, and if needed further gas separators 23 in succession. At each stage more and more oxygen molecules O2 are removed so that at the hydrogen outlet 27 of the last stage the hydrogen molecules are available in the targeted purity.

In order to improve the efficiency of the separation, in the present embodiment the sidewall 29 of the gas separator is not a perfect circle but is an ellipse. An ellipse has a small axis and perpendicular to the small axis a long axis. When the gas molecules are forced along the elliptical conical spiral 6 each time, they pass the smaller axis of the elliptical cross section, they are additionally accelerated towards the longer axis of the elliptical cross section in front of them. In the present embodiment the smaller axis of the elliptical cross section at the bottom side 24 is 40 mm and the longer axis of the elliptical cross section is 60 mm. At the top side 25 of each gas separator 21, 22, 23 the smaller axis is 60 mm and the longer axis is 90 mm. This results in an eccentricity ratio of 60 mm divided by 40 mm and 90 mm divided by 60 mm, which is 1.5 for both cross sections. In the present embodiment this ratio is uniform along the central axis of the conical frustum. In this embodiment the eccentricity ratio is the same for all three stages, i.e. the first gas separator device 21, the second gas separator device 22, and the third gas separator device 23.

FIG. 3 shows a cross section of a gas generator 10. A tube 13 is wound in serpentines from the fluid inlet 11 to the gas outlet 12 forming a lattice. As this is a cross section only one layer of lattice is visible and the drawing shows an arrangement of the tubes for only one stack. However, the gas generator 10 comprises a plurality of lattices, one stacked behind each other. With more than one stack the tube 13 at the end 12 of one stack has to be connected with the inlet 11 of the next stack. Ideally the number of stacks is chosen such that sufficient energy is introduced to the gas generator 10 in order to heat up the fluid entering through the fluid inlet 11 to a temperature that changes the phase of the fluid to a gas at the gas outlet 12.

The spray device 18 is inserted in the tube 13 after the fluid inlet 11. It may be inserted at a location where the water flowing through the tube 13 is almost boiling. The collecting tube 30 (not shown in FIG. 3) is connected to a spray medium inlet 19. In case the pressure is not sufficiently high, a compressor arranged between collecting tube 30 and spray medium inlet 19 may be used to increase the pressure of the oxygen to a sufficient level. This compressor may be powered by the steam produced in the gas generator 10 or may be powered by electrical energy.

FIG. 9 shows the spray device 18 in more detail. The oxygen gas molecules enter the spray device 18 at a spray medium inlet 181. The spray device 18 has in a middle part a constriction with a suction inlet 182. Such a spray device uses the well-known Venturi effect. Towards a spray outlet 183 the sucked in water is torn apart by the accelerating oxygen molecules into little droplets and creates a water spray. The enlarged surface of the water droplets supports a faster boiling of the water molecules.

FIG. 4 shows a gas superheater/reactor device 14 with a similar structure. A lattice of tubes 16 extends from a gas inlet 15 to the mixture inlet 26 of the gas separator 21. When stacked together the tubes form a cube. In this embodiment the tubes 16 are arranged such that they create a recess 17, which accommodates the gas separator 21. The gas generator/gas superheater/reactor devices are contained in a common housing 9. The housing 9 further contains a water reservoir 7 with a water refill inlet 71. Between the water reservoir 7 and the superheater/reactor device 14 are arranged thermoelectrical generator pads 8. Due to the high temperature difference between the water reservoir 7 and the gas superheater/reactor device 14 the thermoelectrical generator pads 8 can produce considerable electrical power. This power may be applied directly, or after conversion to a suitable voltage to create an electrostatic field in the gas separator 21, 22, 23. For this purpose the bottom section 24 of the gas separator must be insulated from the top section 25 of the gas separator. The output voltage of the thermoelectrical generator pads 8, or voltage converter respectively is applied to the bottom section 24 and the top section 25. The electrostatic field in addition accelerates the gas molecules.

FIG. 5 shows in an alternative embodiment a reactor module 40 to build a gas generator/gas superheater/reactor device with tubes 41 which are orientated in parallel, in the drawing from the bottom-side to the topside. The tubes 41 are thermally connected by a connecting grid 42. At the lower end of the drawing the tubes 41 extend into a bottom plate 43 and on the upper side of the drawing the tubes 41 extend into a top plate 44. In case the reactor module is a bottom module the bottom plate 43 comprises channels, which cannot be seen in the drawings, which connect two neighboured tubes 41. In case the reactor module 40 is an intermediate module the tubes 41 extend in the bottom plate into through holes. A bottom module and an intermediate module both have a top plate 44 with through holes 46 which allow the fluids in the tubes 41 to pass to another module which may be placed on top of the reactor module 40. This may be a top module, which mirrors the bottom module, i.e. the bottom plate 43 has through holes and the top plate has channels to connect a pair of tubes such that the tubes of the whole a gas generator/gas superheater/reactor device circulates in a serpentine through all tubes 41. In that case, gas outlet 45 may be connected to a gas separator module 2. With this modular design the gas generator/gas superheater/reactor device can be adopted to a size that corresponds with the available heat and the desired output of split gas molecules.

Another embodiment of the gas generator/gas superheater/reactor device 50 is shown in FIG. 6. In contrast to the reactor modules, it is built as non-modular. In this embodiment the tubes 51 run from the bottom plate 53 to the top plate 54. Similar to the previous embodiment, the top plate 54 and the bottom plate 53 provide channels which connect each pair of neighboured tubes 51 such that the tubes 51 form a single serpentine with one fluid inlet and one mixture outlet. The mixture outlet is concealed in this drawing and is below the first gas separator module 21. In this embodiment three gas separator modules 21, 22, 23 are connected in line. The last gas separator modules comprise the hydrogen outlet 27. The oxygen outlets 28 end in the oxygen collection tube 33.

In one of the applications of the invention is the use of the produced hydrogen H2 in a combustion engine. As it is known, when hydrogen is combusted with air, it burns with the oxygen contained in the air to water, so that it is environmentally friendly.

FIG. 7 shows a gas generator/gas superheater/reactor device 60, or thermal converter 60 which is composed of a gas generator device 40 and a gas superheater/reactor device 50. The superheater/reactor device 50 comprises a recess dimensioned to accommodate the gas separator modules 21, 22, 23 fit. This type of construction allows for an optimized use of space and avoids at the same time that heat is wasted. FIG. 7 shows an application of the thermal converter 60 in a combustion engine. In FIG. 7 the bottom of the thermal converter 60 (lower side of the figure) is placed on top of an exhaust manifold of a combustion engine. The arrows show the exhaust gases flowing from the exhaust manifold into the thermal converter 60, through the lattice of tubes 41, 51 to the top of the thermal converter 60. The thermal converter 60 is enclosed by a housing, which is not shown for reasons of clarity. The housing has inlets 91 (FIG. 8) on the bottom side which match openings of the exhaust manifold and has outlets 92 (FIG. 8), which match openings of an exhaust collector manifold, which is placed on top of the thermal converter. The housing 9 ensures that the under-utilized heat of the exhaust gas of the combustion engine is guided into the thermal converter 60.

FIG. 8 shows the thermal converter from a similar angle as in FIG. 7, but with wire frames indicating the housing 9 of the thermal converter 1,2.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the widest scope consistent with the principles and novel features disclosed herein.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A thermal converter (1, 2) for generating from a parent compound a first fluid of first molecules (H₂) with a first molecular weight and a second fluid of second molecules (O₂) with a second molecular weight, wherein the first molecular weight of the first molecules (H₂) is less than the second molecular weight of the second molecules (O₂), the thermal converter comprising:
a spray device (18) for generating from the parent compound in fluid form a spray, which is supplied to a reaction device (1) for splitting the parent compound into a mixture compound of the first molecules (H₂) and the second molecules (O₂);
a gas separator device (2) comprising a mixture inlet (26) for the mixture compound of the first and the second molecules and a first and a second outlet (27, 28), the first outlet (27) providing substantially the first molecules (H₂) and the second outlet (28) providing substantially the second molecules (O₂).

2. The thermal converter (1,2) according to claim 1, wherein the spray device (18) makes use of the Venturi effect.

3. The thermal converter (1,2) according to claim 1, wherein the spray device (18) is connected with a suction inlet (182) to a fluid reservoir (7) wherein the fluid reservoir (7) contains the parent compound, and with a spray outlet (183) to a gas generator inlet of the reactor device (1).

4. The thermal converter (1,2) according to claim 1, wherein either the first or the second outlet (27,28) of the gas separator (2) is connected to a spray medium inlet (181) of the spray device (18).

5. The thermal converter (1, 2) according to claim 3, the reaction device (1) further comprising a gas generator (10), an inlet of which is connected to the spray outlet (183) of the spray device (18).

6. The thermal converter (1, 2) according to claim 1, wherein the reaction device (1) is heated by a heat source (4).

7. The thermal converter (1,2) according to claim 6, wherein the reaction device (1) is comprised of a lattice of connecting tubes exposed to the heat source (4).

8. The thermal converter (1,2) according to claim 4, wherein the spray device (18) has a constriction and wherein the suction inlet (182) leads into the constriction.

9. An arrangement of a thermal converter (1,2) according to claim 1 and a combustion engine (3) for the combustion of a first stream of first molecules (H₂) wherein a first outlet (27) of the thermal converter (1,2) is connected to intake valves of the combustion engine (3).

10. The arrangement according to claim 9, wherein heat produced by the combustion engine (3) is transferred to the reactor device (2) of the thermal converter (1, 2).

11. A reaction device (1) for generating from a parent compound a first fluid of first molecules (H₂) with a first molecular weight and a second fluid of second molecules (O₂) with a second molecular weight, wherein the first molecular weight of the first molecules (H₂) is less than the second molecular weight of the second molecules (O₂), the reaction device (1) comprising a spray device (18) for generating from the parent compound in fluid form a spray, which is supplied to the reaction device (1) for splitting the parent compound into a mixture compound of the first molecules (H₂) and the second molecules (O₂).

12. A method to generate hydrogen and oxygen gas comprising the steps of:
converting water into a spray of water droplets;
exposing the water droplets to a first heat source for generating steam;
exposing the steam to a second heat source for superheating the steam into supercritical steam;
splitting the supercritical steam into hydrogen molecules (H₂) and oxygen molecules (O₂);
separating the hydrogen molecules (H₂) and the oxygen molecules (O₂).
